(19) United States
(12) Patent Application Publication
(10) Pub. No.: US 2006/0000387 A1
(43) Pub. Date: Jan. 5, 2006

(54) Ink composition for ink-jet printing and ink-jet printing

(75) Inventors: Yun-I Liu, Taoyuan Hsien (TW); Yu-Chang Shen, Taipei (TW); Kai-Pin Chou, Taoyuan Hsien (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/143,435

(22) Filed: Jun. 3, 2005

(30) Foreign Application Priority Data
Jun. 30, 2004 (TW) 93119456

(51) Int. Cl. C09D 11/00

(52) U.S. Cl. 106/31.27; 106/31.6; 106/31.59; 106/31.89

(57) ABSTRACT

An ink composition for inkjet printing and ink-jet printing method employing the same. The ink composition comprises a colorant, an aqueous solution medium, and a non-ionic surfactant with HLB not more than 10.6. Compared with an ink including a non-ionic surfactant with HLB of more than 10.6, the ink composition of the present invention has improved smear resistance, thus enhancing inkjet printing quality.

### BACKGROUND

The present invention relates to an ink-jet printing method, and more particularly to an ink-jet printing method employing an ink composition comprising a non-ionic surfactant with HLB≦10.6.

Ink-jet printing technology is highly developed and has the advantages of low price, low noise, and good full-color printing quality. Also, various substrates including plain paper, paper for special printing, and transparency can be printed.

A suitable ink-jet cartridge must be capable of more than 10 million prints without clogging of the printing nozzle. For black ink-jet printing, the ink composition must exhibit waterfastness with no feathering or bleeding after printing. In addition, a successful ink composition should exhibit smear-resistance.

In general, few inks can meet the above requirements. For example, ink that has high optical density will exhibit poor smear-resistance. And, ink that has no bleeding after printing will have poor optical density (OD).

Ink composition used for ink-jet printing can be classified into dye-based ink and pigment-based ink. Dye-based ink has superior color brightness, but poor light resistance. Moreover, dye has good water solubility; therefore, it has poor water resistance. When the printed image using dye-based ink contacts water, dye is dissolved again, thus affecting printing quality. An ink-jet ink using pigment as the colorant has better water-fastness and light resistance than a dye-based ink. However, dispersants or adhesives must be added to the pigment-based ink. In addition, pigment has a larger particle size, which easily causes precipitation and coagulation, thus clogging the nozzle and negatively impacting printing properties. In order to combat this problem, reduction of the coagulation force of the pigment particles by adding a surfactant such as resinous material or amine is required.

Dispersion of pigment particles can be improved by two methods. First, pigment particles with charges formed thereon are provided to induce an electrical repulsion effect (i.e. the DLVO theory), thereby generating an energy gap therebetween due to the opposition of potential energy of pigment particles. Second, pigment particles with bulky substituent groups are prepared to induce a steric hindrance effect, preventing the pigment particles from condensation or combination.

Surfactants can be classified into anionic, cationic, non-ionic, or amphoteric types, wherein non-ionic surfactants comprise hydrophilic segments and hydrophobic segments. The surfactant molecular hydrophilic or oleophilic strength may be expressed as the hydrophile/lipophile balance (HLB) value, where the HLB value is conveniently defined by a ratio HLB=20 (molecular weight of hydrophilic group)/(molecular weight of surfactant molecule). Surfactants have HLB value in the range of from 0 to 20. Surfactants with higher HLB value exhibit highly hydrophilic properties. On the contrary, surfactants with lower HLB value exhibit lowly hydrophilic properties. The main function of the surfactant is to decrease the surface tension of the ink.

U.S. application Ser. No. 09/120,046 discloses a method for improving smear-resistance of ink by adding latex polymer as an additive. The ink comprising latex polymer, however, is inconvenient for ink-jet printing. Furthermore, U.S. Pat. No. 6,178,498 B1 discloses an ink composition, comprising latex polymer, 3-hexyne-2,5-diol and 1,2-octanediol, for improving printing quality.

In the conventional technology, a method of improving smear-resistance using surfactants has not been disclosed.

### SUMMARY

The invention provides an ink composition with high smear-resistance comprising a colorant, an aqueous solution medium, and a non-ionic surfactant with HLB not more than 10.6.

Further provided is an ink-jet printing method, comprising the following steps. A pigment-based ink composition comprising a colorant, an aqueous solution medium, and a non-ionic surfactant with HLB not more than 10.6 is also provided. Then, the ink composition is then ink-jet printed onto a recording substrate.

The premise is that the same colorant and aqueous solution medium, the ink compositions comprising non-ionic surfactant with HLB not more than 10.6 have superior smear-resistant in comparison with those ink compositions comprising non-ionic surfactant with HLB more than 10.6.

### DETAILED DESCRIPTION

The ink composition of the invention can at least comprise a colorant, an aqueous solution medium, and a surfactant.

As a main feature and a key aspect, the surfactant must be a non-ionic surfactant and has a HLB value not more than 10.6, preferably of between 4 and 10.6. Due to the specific hydrophilic and hydrophobic characteristics of the non-ionic surfactant, the colorant particles disperse uniformly in the aqueous solution medium, thereby improving the smear-resistance and printing quality.

The colorant can be a pigment or dye present in an amount of 1 to 15 weight %, preferably 1 to 8 weight %, based on the total weight of the ink composition. The brightness of colorant relates to the particle size thereof. Generally, the inkjet nozzle has a diameter of about 20-50 μm, and colorant used in embodiments of the invention has a particle size of less than 1 μm, preventing clogging the nozzle of ink cartridge. Suitable pigments can be AcryJet Series from Rohm&Haas, Cab-O-Jet series from Cabot, BonJet CW series from Orient, MicroPigmo series from Orient, Hostafine series from Clariant, Duasyn SF Seriesfrom Clariant GmbH, Dusayn MB-01 liquid LP2598 from Clariant, Dusayn MB-01 liquid LP2599 from Clariant, ProJet Series from Avecia, Bayscipt Series from Bayer AG, Special Turquoise Blue AE liquid from Bayer, Special Brilliant Series from Bayer, Special yellow N-S AY-9 from Bayer, Experimental PC Series from Bayer, Access Series, Palmer Series, Liquitant Series from Milliken Chemical, Y1189, Y104, Y178, M377, M1114 from Ilford, Water Color Series from Orient, Basacid Series from BASF, or Basonyl Series from BASF.

The non-ionic surfactant with HLB not more than 10.6 can be present in an amount of 0.001 to 10 weight %, preferably 0.001 to 3.5 weight %, based on the total weight of the ink composition. The non-ionic surfactant with HLB not more than 10.6 can be Surfynol 104, Surfynol 400 Series (Air Products), Tergitol 15-S-n Series, Tergitol TMN-Series, Tergitol X-Series (UCC), Honon TX-n Series, HOLOF Series(HOCLEAN), TRE Series, ENHOL NP Series, ENHOL BPE Series, ENHOL LE Series, ENHOL TAE Series, ENHOL TME Series (En Hou), SINOPOL Series, SINCOL Series, SINOMAL Series, SINONOX Series, or ABLUNOL Series.

In the invention, the ink composition has the surface tension of 25˜45 dyne/cm, preferably of 30˜40 dyne/cm.

The aqueous solution medium can be present in an amount of 80 to 98 weight %, preferably of 90 to 95 weight %, based on the total weight of the ink composition. In addition to water, the aqueous solution medium can further include an organic solvent, emulsifier, pH buffer solution, chelating agent, biocide, humectant, preservative, dispersant, dyeing assistant, or combination thereof.

Suitable organic solvent can be cyclohexane, methanol, ethanol, diethylene glycol, triethylene glycol, propylene glycol, butylenes glycol, pentylene glycol, polyethylene glycol, or hexylene glycol.

Suitable emulsifier can be A-102 from CYTEC, LF-4 from CYTEC, 1,3-BG from KYOWA, OG from KYOWA, BEPG from KYOWA, PD-9 from KYOWA, EP-810 from AIR PRODUCT, AQUAROME AGENT 44 from The Independent Fragrance, 2-propanol, di-1,2-propylene glycol, 2-pyrrolidone, N-methyl-2-pyrrolidone, 2,4,7,9-tetramethyl-5-decyne-4,7-diol, or 1,1,1-trimethylolpropane.

Suitable humectant, dispersant, and dyeing assistants can be CT-141 from AIR PRODUCT, CT-151 from AIR PRODUCT, OT-75 from CYTEC, GPG from CYTEC, OT-70PG from CYTEC, polyethandiol, polypropandiol, EO/PO copolymer, BO/EO copolymer, sodium dioctyl sulfosuccinate, alkylene oxide adduct of acetylene glycol, polybutyl resin, cellulose derivative, styrene/acrylic copolymer resin, maleic acid/styrene copolymer, or polymer containing hydrophilic segments and hydrophobic segments.

Suitable pH buffer solution can be diethanolamine, triethanolamine, hydroxides of alkali metals, or carbonates of alkali metals, such as lithium hydroxide, sodium hydroxide, potassium hydroxide, ammonium hydroxide, carbonates of alkali metals, lithium carbonate, sodium carbonate, or potassium carbonate.

Chelating agent can be sodium ethylenediaminetetraacetate, trisodium nitrilotriacetate, hydroxyethyl ethylenediamine trisodium acetate, diethylenetriamino pentasodium acetate, or uramil disodium acetate.

A biocide or preservative can be added to inhibit the growth of microorganisms. Additives can be added into the ink composition for improving the weatherability and photostability.

The following examples are intended to illustrate the invention more fully without limiting their scope, since numerous modifications and variations will be apparent to those skilled in this art.

### EXAMPLE 1

Ink Compositions 1a˜1j, same components except for non-ionic surfactant, were prepared by mixing the components shown in the Table 1 and had the same surface tension of 30 dyne/cm.

TABLE 1
components of Ink Compositions la˜lj

| | | |
|---|---|---|
| colorant | BonJet CW-2 (from Orient) | 4 wt% |
| humectant | 1,5-pentanediol glycol | 10 wt% |
| organic | N-methyl-pyrrolidone | 5 wt% |
| solvent | | |
| polymer | Polyethylene Glycol 200 | 5 wt% |
| solvent | (from Adrich) | |
| non-ionic | as described below | 0.5 wt% |
| surfactants | | |
| biocide | Mergal K7 (from Clariant) | 0.5 wt% |
| solvent | water | 75 wt% |

non-ionic surfactants of Ink Compositions la˜lj

| Ink | non-ionic | | |
|---|---|---|---|
| Composition | surfactant | maker | HBL value |
| 1a | Surfynol 420 | Air Products | 4 |
| 1b | Surfynol 104E | Air Products | 4 |
| 1c | Surfynol 440 | Air Products | 8 |
| 1d | TX-3 | HOCLEAN | 8.1 |
| 1e | Tergitol 15-S-3 | UCC | 8.3 |
| 1f | Tergitol 15-S-5 | UCC | 10.6 |
| 1g | TX-6 | HOCLEAN | 11.7 |
| 1h | Tergitol 15-S-7 | UCC | 12.4 |
| 1i | Surfynol 465 | Air Products | 13 |
| 1j | Surfynol 485W | Air Products | 17 |

Each of the Ink Compositions 1a˜1j were printed respectively on to a paperon paper (70 gsm) and TRANSMATE paper (70 gsm) in a commercially available inkjet printer (HP DeskJet 930C). The printed papers were subjected to smear-resistance test as described below. A commercially available fluorescence pen (Pentel S512) was used to write on the image after inkjet printing. The colorant amount carried by the fluorescent pen was measured to determine the smear resistance of the black image. The results are shown in Table 2.

TABLE 2

| | smear resistance | |
|---|---|---|
| Ink Composition | paperon paper | TRANSMATE paper |
| 1a | ◯ | ◯ |
| 1b | ◯ | ◯ |
| 1c | ◯ | ◯ |
| 1d | ◯ | ◯ |
| 1e | ◯ | ◯ |
| 1f | Δ | Δ |
| 1g | X | X |
| 1h | X | X |
| 1i | X | X |
| 1j | X | X |

Note:
◯: the fluorescent line carries little colorant.
Δ: the fluorescent line carries colorant.
X: all of the fluorescent lines are colorant.

### EXAMPLE 2

Ink Compositions 1a˜2j, having the same components except for non-ionic surfactant, were prepared by mixing the components shown in the Table 3 and had the same surface tension of 30 dyne/cm.

TABLE 3
components of Ink Compositions 2a˜2j

| | | |
|---|---|---|
| colorant | Pro-Jet Fast black 2CF2 liquid | 4 wt% |
| | (from Avecia) | |
| humectant | 1,5-Pentanediol Glycol (from | 10 wt% |
| | Adrich) | |
| organic | N-mathyl-pyrrolidone (from | 5 wt% |
| solvent | Adrich) | |
| polymer | Polyethylene Glycol 200 (from | 5 wt% |
| solvent | Adrich) | |
| non-ionic | as described below | 0.5 wt% |
| surf actants | | |
| biocide | Mergal K7 (from Clariant) | 0.5 wt% |
| solvent | water | 75 wt% |

non-ionic surfactants of Ink Compositions 2a˜2j

| Ink | non-ionic | | |
|---|---|---|---|
| Composition | surfactant | maker | HBL value |
| 2a | Surfynol 420 | Air Products | 4 |
| 2b | Surfynol 104E | Air Products | 4 |
| 2c | Surfynol 440 | Air Products | 8 |
| 2d | TX-3 | HOCLEAN | 8.1 |
| 2e | Tergitol 15-S-3 | UCC | 8.3 |
| 2f | Tergitol 15-S-5 | UCC | 10.6 |
| 2g | TX-6 | HOCLEAN | 11.7 |
| 2h | Tergitol 15-S-7 | UCC | 12.4 |
| 2i | Surfynol 465 | Air Products | 13 |
| 2j | Surfynol 485W | Air Products | 17 |

Each of the Ink Compositions 2a˜2j were printed respectively onto a paperon paper (70 gsm) and TRANSMATE paper (70 gsm) in a commercially available inkjet printer (HP DeskJet 990C). The printed papers were subjected to smear-resistance test as described below. A commercially available fluorescent pen (Pentel S512) was used to write on the image after inkjet printing. The colorant amount carried by the fluorescent pen was measured to determine the smear resistance of the black image. The results are shown in Table 4.

TABLE 4

| | smear resistance | |
|---|---|---|
| Ink Composition | paperon paper | TRANSMATE paper |
| 2a | ◯ | ◯ |
| 2b | ◯ | ◯ |
| 2c | ◯ | ◯ |
| 2d | ◯ | ◯ |
| 2e | ◯ | ◯ |
| 2f | Δ | Δ |
| 2g | X | X |
| 2h | X | X |
| 2i | X | X |
| 2j | X | X |

Note:
◯: the fluorescent line carries little colorant.
Δ: the fluorescent line carries colorant.
X: all of the fluorescent lines are colorant.

### EXAMPLE 3

Ink Compositions 3a, 3d, 3f, and 3i, having the same components except for non-ionic surfactant, were the same prepared as Example 1 except for substitution of 30 dyne/cm of surface tension for 40 dyne/cm.

Each of the Ink Compositions 3a, 3d, 3f, and 3i were printed respectively onto a paperon paper (70 gsm) in a commercially available inkjet printer (HP DeskJet 990C). The printed papers were subjected to smear-resistance test as described below. A commercially available fluorescent pen (Pentel S512) was used to write on the image after inkjet printing. The colorant amount carried by the fluorescent pen was measured to determine the smear resistance of the black image. The results are shown in Table 5.

TABLE 5

| Ink | | |
|---|---|---|
| Composition | HBL value | smear resistance |
| 3a | 4 | ◯ |
| 3d | 8.1 | ◯ |
| 3f | 10.6 | Δ |
| 3i | 13 | X |

Note:
◯: the fluorescent line carries little colorant.
Δ: the fluorescent line carries colorant.
X: all of the fluorescent lines are colorant.

### EXAMPLE 4

Ink Compositions 4a, 4d, 4f, and 4i, having the same components except for non-ionic surfactant, were the same prepared as Example 2 except for substitution of 30 dyne/cm of surface tension for 40 dyne/cm.

Each of the Ink Compositions 4a, 4d, 4f, and 4i were printed respectively onto a paperon paper (70 gsm) in a commercially available inkjet printer (HP DeskJet 990C). The printed papers were subjected to smear-resistance test as described below. A commercially available fluorescent pen (Pentel S512) was used to write on the image after inkjet printing. The colorant amount carried by the fluorescent pen was measured to determine the smear resistance of the black image. The results are shown in Table 6.

TABLE 6

| Ink | | |
|---|---|---|
| Composition | HBL value | smear resistance |
| 4a | 4 | ◯ |
| 4d | 8.1 | ◯ |
| 4f | 10.6 | A |
| 4i | 13 | X |

Note:
◯: the fluorescent line carries little colorant.
Δ: the fluorescent line carries colorant.
X: all of the fluorescent lines are colorant.

It can be seen from the above experimental results that ink components having a non-ionic surfactant with HLB not more than 10.6 have superior smear-resistant in comparison with those ink compositions comprising non-ionic surfactant with HLB more than 10.6. None of the prior or related references disclose that varied HBL value of non-ionic surfactant would yield an ink composition with distinct smear-resistance.

Moreover; the ink composition of the present invention has excellent waterfastness, bleed- and smear-resistance, and high printing quality.

While the invention has been described by way of example and in terms of preferred embodiment, it is to be understood that the invention is not limited thereto. It is therefore intended that the following claims be interpreted as covering all such alteration and modifications as fall within the true spirit and scope of the invention.

What is claimed is:

1. A ink composition, comprising:
a colorant;
an aqueous solution medium; and
a non-ionic surfactant with HLB value not more than 10.6.

2. The ink composition as claimed in claim 1, wherein the colorant is pigment or dye.

3. The ink composition as claimed in claim 1, wherein the non-ionic surfactant with HLB value 4 to 10.6.

4. The ink composition as claimed in claim 1, wherein the colorant is present in an amount of 1 to 15 weight %.

5. The ink composition as claimed in claim 1, wherein the non-ionic surfactant is present in an amount of 0.001 to 10 weight %.

6. The ink composition as claimed in claim 1, wherein the non-ionic surfactant is present in an amount of 0.001 to 3.5 weight %.

7. The ink composition as claimed in claim 1, wherein the aqueous solution medium comprises organic solvent, emulsifier, pH buffer solution, chelating agent, biocide, humectant, preservative, dispersant, dyeing assistant, or combination thereof.

8. An inkjet printing method for improving smear-resistance thereof, comprising:
providing a ink composition, wherein the ink composition comprises a colorant, an aqueous solution-medium, and a non-ionic surfactant with HLB value not more than 10.6; and
inkjet printing the ink composition onto a recording substrate.

9. The method as claimed in claim 8, wherein the colorant is pigment or dye.

10. The method as claimed in claim 8, wherein the non-ionic surfactant with HLB value 4 to 10.6.

11. The method as claimed in claim 8, wherein the colorant is present in an amount of 1 to 15 weight %.

12. The method as claimed in claim 8, wherein the non-ionic surfactant is present in an amount of 0.001 to 10 weight %.

13. The method as claimed in claim 8, wherein the non-ionic surfactant is present in an amount of 0.001 to 3.5 weight %.

14. The method as claimed in claim 8, wherein the aqueous solution medium comprises organic solvent, emulsifier, pH buffer solution, chelating agent, biocide, humectant, preservative, dispersant, dyeing assistant, or combination thereof.
